(19) United States
(12) Patent Application Publication
(10) Pub. No.: US 2016/0019765 A1
(43) Pub. Date: Jan. 21, 2016

(54) System and method for tracking and recovering a lost or stolen object

(71) Applicant: Daniel P. Stokes, Chicago, IL (US)

(72) Inventor: Daniel P. Stokes, Chicago, IL (US)

(21) Appl. No.: 13/766,489

(22) Filed: Feb. 13, 2013

Related U.S. Application Data
(60) Provisional application No. 61/701,875, filed on Sep. 17, 2012.

(51) Int. Cl. G08B 13/24

(52) U.S. Cl. CPC G08B 13/2462

(57) ABSTRACT

A method and apparatus is provided for identifying and reporting unauthorized movement of an object. The method provides for identifying when movement of an object is unauthorized such that 1) when a tracking device affixed to the object is moving relative to the surface of the earth while the user is a predetermined distance away from the tracking device, or 2) when a tracking device is moving relative to the surface of the earth while the user is not moving in the same speed and direction as the tracking device.

### BACKGROUND

Vehicle thefts are a widespread problem, and are particularly severe in major cities. Bicycles, automobiles, and other transportation devices constitute only a fraction of the examples of this issue.

More broadly, theft of objects that are intended to move when, and only when, the owner accompanies their movement, is a significant problem.

### SUMMARY

The two most effective solutions to the issue of theft are 1) determine as soon as possible when an object has been lost or stolen or is at threat of being stolen, and 2) make it easy to inform the object's owner, law enforcement, or other parties of information that will help them to recover the object.

The system and method claimed and disclosed herein provide these two solutions.

The system and method in question connect a spatial tracking device with a receiver and connect the receiver with a processing unit. The receiver, or the processing unit, is adapted to include and/or interface with its own self-location reporting system. In this way, the locations and/or motions of both the spatial tracking device and the receiver/processing unit can be tracked and/or compared.

The processing unit is adapted to process the data it receives from both the spatial tracking device and from the self-location reporting system. Also, the processing unit is adapted to send alerts to selected parties (i.e., the user and/or other individuals or organizations) if its processing of the location or movement data indicates that a theft is taking place.

The self-location reporting system can comprise, for example, a user's mobile phone. If the mobile phone accompanies the user, the system is ideally poised to send an alert if it determines—based on location and/or movement data—that a theft is occurring. This is because of the myriad of physical items, such as vehicles, that are normally transported only when they are in close proximity to a person's mobile phone, and because of the typical practice of a person to keep one's mobile phone with him or her at given times.

Another component of the system and method involves facilitating the conveyance of information to law enforcement, or to other parties, that can help them recover an object. The system can be adapted to send relevant, context-sensitive information to either law enforcement or other parties, including but not limited to a physical description of the object, the object's current location, the object's last known location, and/or the time the object began its unauthorized motion. This or similar information can be provided at any time by the system's user, or automatically by the system itself. Context-sensitive information can also be provided ahead of time, stored, and retrieved when the processing unit determines that the object is being appropriated.

The system and method can also be adapted not only to convey information to other parties, but also to receive information from other parties. This allows the system and method to receive, for example, information from another party who observes the distressed object, recognizes its physical description, and wishes to inform the object's owner of the time and place that it was observed.

Currently, a number of systems and methods for tracking stolen items use a perimeter system which sends an alert if the item goes, or is taken, outside of a pre-set perimeter. This creates its own problems, such as practicality; a geo-perimeter that is too large, for example, will not alert the user when the object is taken, but rather will delay the alert until the perimeter in question is crossed. Delay lessens the chance that a stolen object can be recovered.

The system disclosed herein, though, solves the problem more directly by instantly identifying when unauthorized movement takes place. It also can define “unauthorized movement” in a way that corresponds much more closely to the actual movement of stolen objects—e.g., when an item moves, or is moved, without its owner present and moving along with the item.

Additionally, with portable devices, one ever-present issue is battery life. The tracking device component of the disclosed system can be deactivated by the user; or it can be adapted to use its location detection ability only when motion is detected; or it can be adapted to use its motion and/or location detection ability only when the user causes another communications device under their control to activate the tracking device, or only when the user has left the device alone, (i.e., when the user is a certain distance away). Each of these are meant to minimize battery consumption during those times when the risk of loss is low, when the object is secured by another means (e.g., inside the user's locked garage), or when the user is with the object, or very near by the object, and limited or no object tracking is necessary.

### BRIEF DESCRIPTION OF THE DRAWINGS

FIG. 1 is a simplified representation of a spatial tracking device 130 in conjunction with a physical item.

FIG. 2 is a simplified block diagram of a representative spatial tracking device 130 shown in FIG. 1.

FIG. 3A is a simplified diagram of one representative embodiment of the invention, in which a spatial tracking device 130 operates in conjunction with a communications intermediary 310 and a mobile communications device 340.

FIG. 3B is a basic schematic of a communications intermediary 310 operating in conjunction with a representative mobile communications device 340.

FIG. 3C is a basic schematic of a spatial tracking device 130 operating in conjunction with a representative mobile communications device 340.

FIG. 4 is a basic diagram of a representative mobile communications device 340 from FIG. 3A.

FIG. 5 is a block diagram of the representative application 440 shown in FIG. 4.

FIG. 6 is a block diagram of the representative self-directed recovery system 542 shown in FIG. 5.

FIG. 7 is a block diagram of the representative multiple-user assisted recovery system 544 shown in FIG. 5.

FIG. 8 is a block diagram of the representative alert 710 and communication & identification 720 block elements in FIG. 7.

FIG. 9A is a block diagram of a representative system and/or method for determining whether the spatial tracking device 130 exceeds a certain distance from the receiver 342.

FIG. 9B is a block diagram of an alternate representative system and/or method for determining whether the spatial tracking device 130 exceeds a certain distance from the receiver 342.

FIG. 10 is a block diagram of a representative system and/or method for determining whether to activate or deactivate the tracking and/or theft detection features of the spatial tracking device 130.

### DETAILED DESCRIPTION OF THE INVENTION

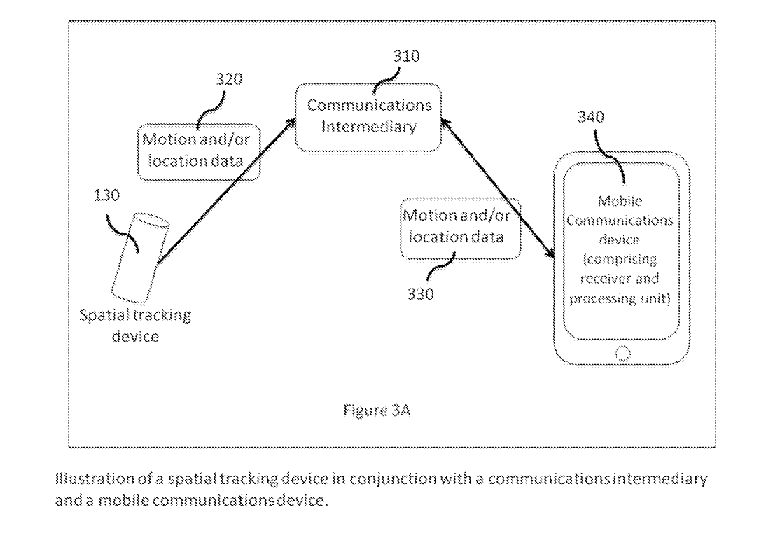

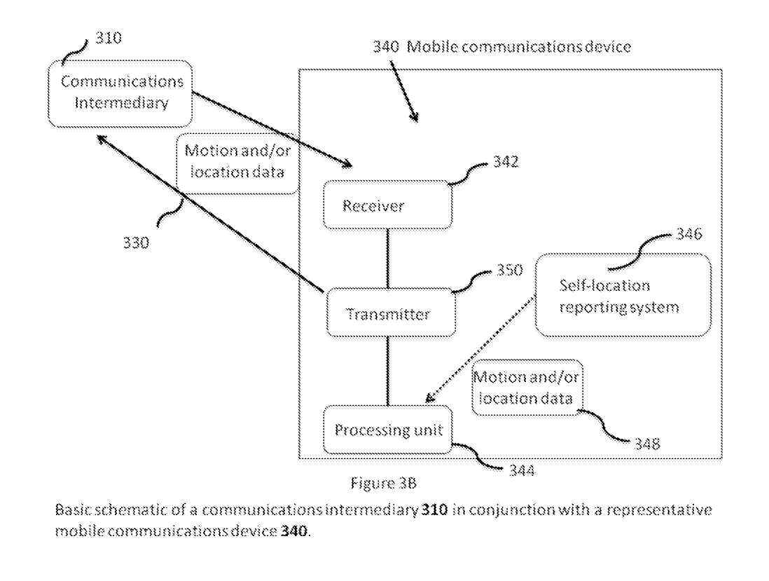

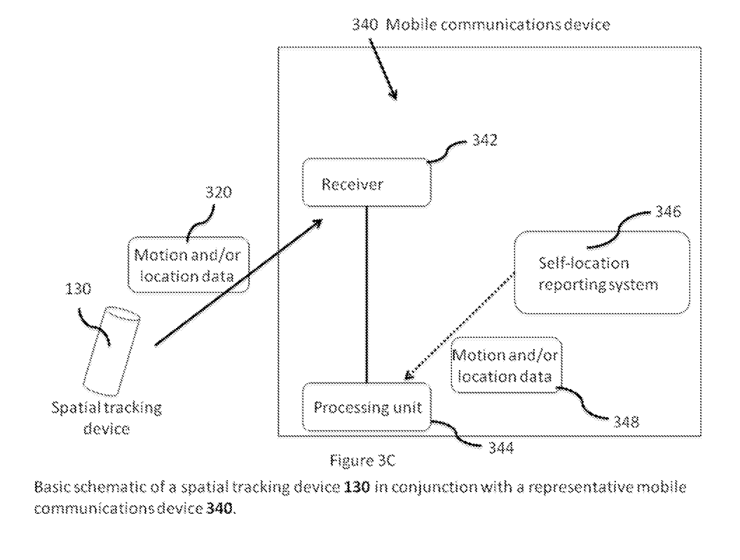

Embodiments of the presently claimed and disclosed invention are directed toward a system for, and method of, linking a spatial tracking device 130 to a receiver 342 and a processing unit 344. Either the receiver 342 or the processing unit 344 is adapted to include, or to interface with, a self-location reporting system 346 which sends its current location to the processing unit 344. As an illustrative example, a mobile computing device might comprise the receiver 342, self-location reporting system 346 and the processing unit 344 all within one unit, and this mobile computing device might use Bluetooth, Wi-Fi or a cellular network to communicate with the spatial tracking device 130. (See FIGS. 3A, 3B, 3C)

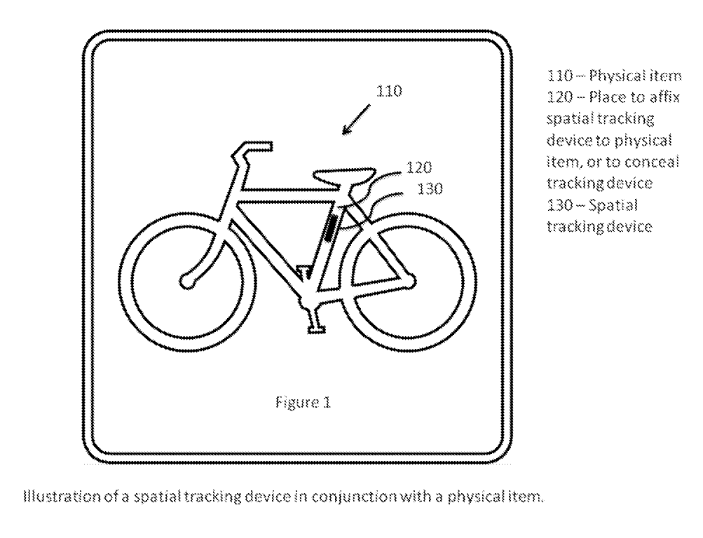

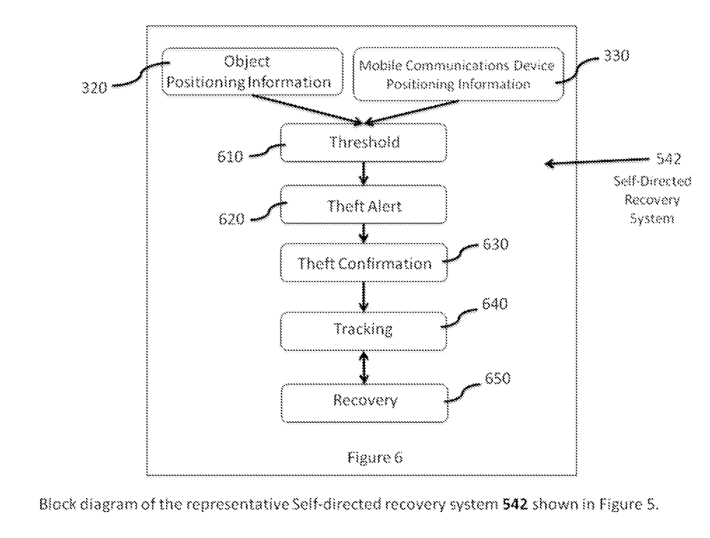

The spatial tracking device 130 in question is adapted to be capable of being affixed to a physical item 110. (See FIG. 1 for a representative embodiment in which the spatial tracking device is affixed to a bicycle.) The processing unit 344 is adapted to alert the user, and/or other parties, when certain context-sensitive data is processed by the processing unit 344 in predetermined ways 610. For example, the processing unit might be programmed to send an alert to law enforcement, to a web site or other online service, to an application or other program running on the user's mobile device, and/or to others in the immediate area with the same application running on their mobile devices. The processing unit might also be programmed to transmit context-sensitive information along with the alert, such as location of the tracking device, motion of the tracking device, and/or a user-created description of the object to which the tracking device is affixed. Transmission of such information could allow an assisted recovery of the object, or could allow the object's owner to carry out a self-directed recovery of the object (see FIG. 6).

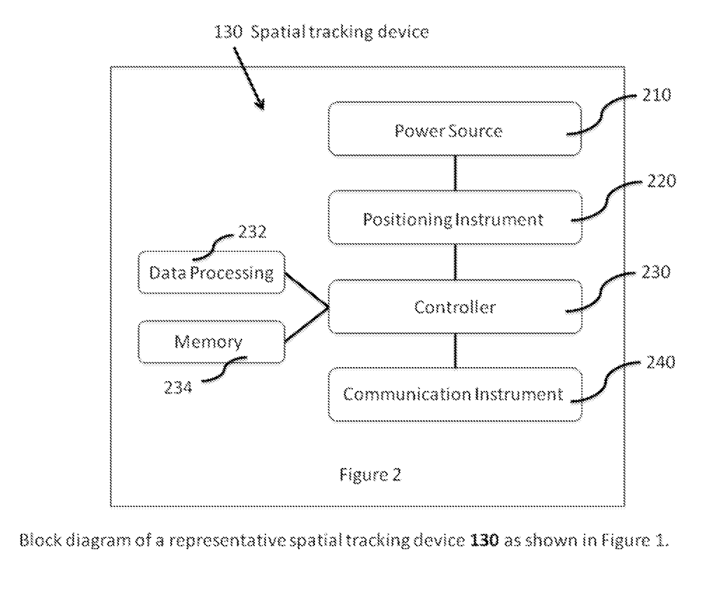

In one embodiment, the spatial tracking device 130 comprises a power source 210, a positioning instrument 220, a controller 230—which, itself, comprises a data processing entity or entities 232 and a memory entity or entities 234—and a communication instrument 240. (See FIG. 2 for a representative diagram.) For example, it might include a positioning instrument which self-locates using the Global Positioning System (GPS), or using data from cellular networks.

In some embodiments, the spatial tracking device 130 communicates with the receiver 342 through a communications intermediary 310 (for example, by using a Wi-Fi or cellular network connection to communicate with the receiver over the Internet). (See FIGS. 3A and 3B for representative diagrams.) In other embodiments, the spatial tracking device 130 communicates with the receiver 342 directly (for example, with Bluetooth or some other short-range direct communication technology). (See FIG. 3C for a representative diagram.)

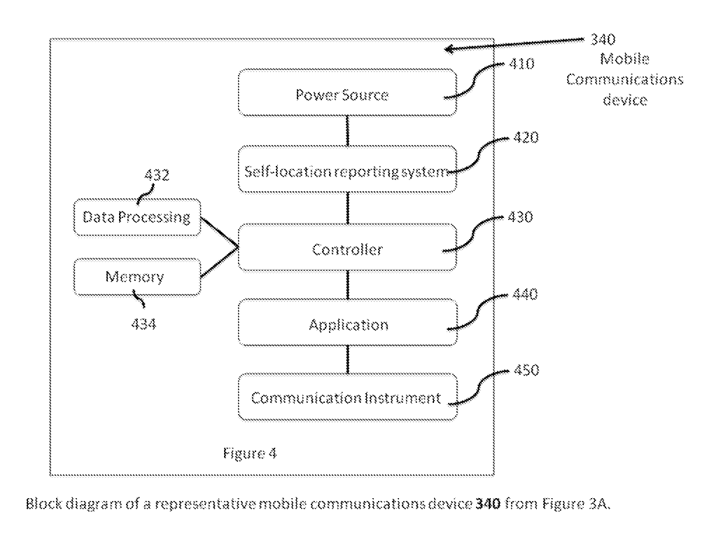

In some embodiments, the receiver 342 and processing unit 344 are combined in one device—for example, a smartphone or other mobile computing device 340. (See FIGS. 3A, 3B, 3C, and 4 for representative diagrams.) In other embodiments, they are separate devices, and the receiver 342 is adapted to include, or to interface with, a transmitter 350 which transmits data to the processing unit 344, including data received from the spatial tracking device 130.

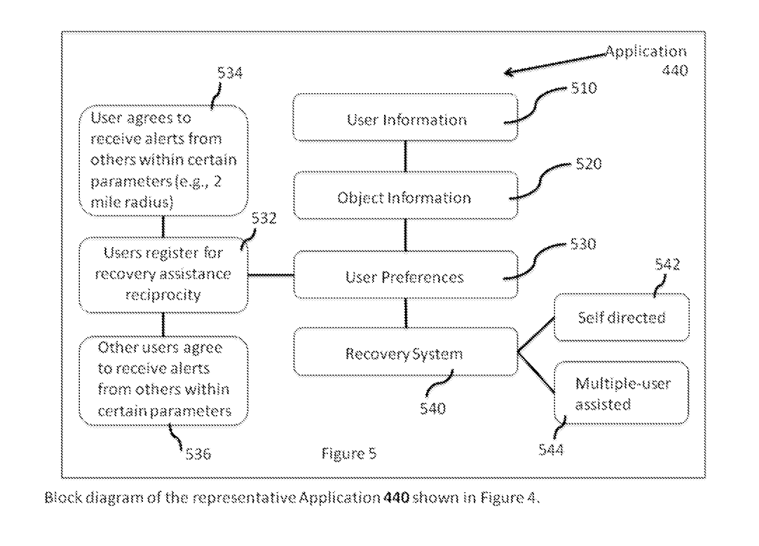

In some embodiments, the processing unit 344 is adapted to link with profile information stored in a user-created profile, including but not limited to user information 510, object information 520, and/or user preferences 530, said profile information either being stored with the processing unit 344 or elsewhere. For example, a user might create a profile with such information as a physical description, brand name, model, and/or other identifying information about the object to which he plans to affix (or has already affixed) the tracking device. (See FIGS. 4 and 5 for representative diagrams.)

In some embodiments, the user's mobile communications device 340 is adapted to run an application 440 with the ability to set user preferences 530. Such preferences could include a setting to receive alerts from others that conform to certain user-selected parameters (for example, to receive alerts from other parties within a one-mile or a two-mile radius, or to volunteer reciprocal assistance to other users of the system who may wish to recover their own lost objects). Such settings could also include the ability to store a user's profile information 510 and/or “object information” 520 relating to or describing a user's physical item 110 to which the spatial tracking device 130 is affixed. Such settings could additionally include the parameters and conditions under which such information is sent to other parties. Such settings might also include the parameters and conditions under which the user agrees to receive alerts or other information from other parties 536. (See FIG. 5 for a representative diagram.)

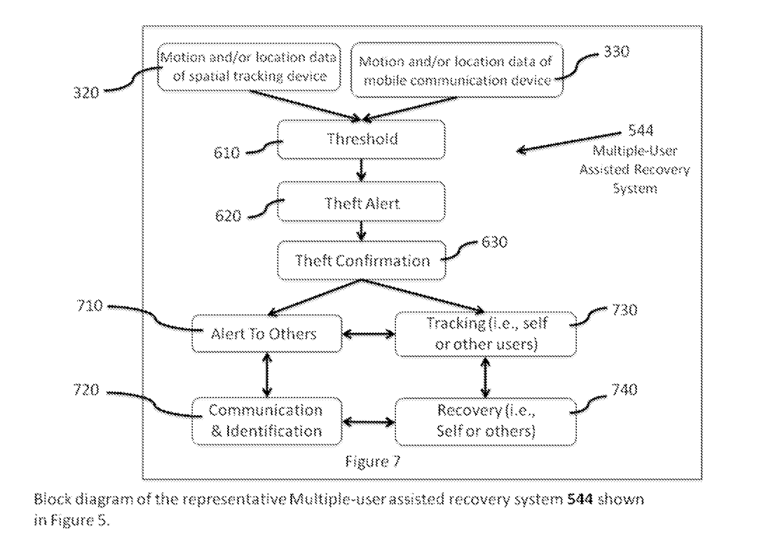

In some embodiments, the processing unit 344 is adapted to send relevant, context-sensitive information, including in the form of an alert 710 to either law enforcement or other parties. (See FIG. 7 for a representative diagram.) The processing unit 344 can also be adapted to associate other data with this context-sensitive information, and to transmit this other data as well. For example, the context-sensitive information might include a description of the object, as well as the current location and direction of motion of the tracking device.

In some embodiments, the system can be adapted to allow a user to bypass certain steps and use only the steps most relevant at a given time. For example, if the tracking system happened to be deactivated, but the user discovers that his/her item is missing, then he or she could directly execute such steps as remotely activating the tracking features of the spatial tracking device and/or sending an immediate alert to others.

In some embodiments, the processing unit 344 is adapted to transmit relevant, context-sensitive information about the object to a remote computer server, web site, or other computing device from which the information can be accessed by others. For example, the processing unit might upload a description of the object, as well as the current location and direction of motion of the tracking device, to a specialized web site from which the object's owner could access the location and/or direction of motion of the tracking device affixed to the object which he/she wants to track. The web site in question might also be adapted to share such information with other parties, such as a passerby or local police.

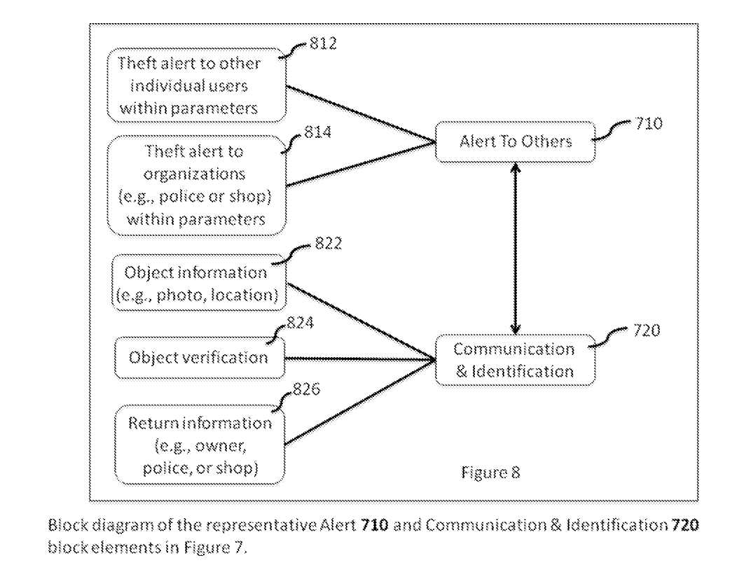

In some embodiments, the processing unit 344 is adapted to process information received from other parties 822 and pass the result along to the user 720. (See FIG. 7, FIG. 8 for representative diagrams.) For example, passerby who observe an object matching a description of an object that the user has earlier reported stolen might send the location, direction of motion, and/or time observed to the user's mobile device containing the processing unit 344. The processing unit 344 can also be adapted to associate or combine this information with other context-sensitive data, such as data from reports of other sightings.

In some embodiments, the processing unit 344 can also be adapted to transmit information received from other parties 822 to other individual users 812, or to police or other organizations 814, and such transmission can be done either automatically or under the user's direction. For example, the processing unit might pass along sighting reports and associated data such as time, location, motion and object description to the police without requiring user intervention, thereby lessening delay and increasing the chance that the object can be recovered.

In some embodiments, the context-sensitive information sent or received by the processing unit 344 comprises spatial location data and/or movement data 320 of the spatial tracking device 130, and/or location or movement data 330 of the self-location reporting system 346, and/or calculated data regarding relative movement of the spatial tracking device 130 compared to a device or unit comprising the self-location reporting system 346. The calculations necessary to determine relative location and/or motion of the two devices would involve a computing device with access to both location and/or movement data 320 of the spatial tracking device 130 and location or movement data 330 of the self-location reporting system 346. Such calculations might be executed by the processing unit 344, or by a different computing device associated with a communications intermediary 310. (See FIGS. 3B, 3C for representative diagrams.) For example, a unit such as a smartphone or other mobile computing device might comprise both a processing unit and a self-location reporting system, and such a unit would be intended to accompany a user. This allows comparison of the user's location and movement with the object's location and movement, as the user's location corresponds to that of the smartphone and the object's location corresponds to that of the affixed tracking device, and in this way, the relative motion and/or location of both can be determined. Software running on the smartphone, or alternatively on a remote computing device or server such as a cloud computer, can be used to make the calculations necessary to determine relative motion.

In some embodiments, the processing unit 344 is adapted to alert the user or other parties when the spatial tracking device 130 is moving relative to the surface of the earth and the self-location reporting system 346 is a predetermined distance 610 away from the tracking device. For example, if the object is moving and yet the user holding the receiver is inside a building 100 feet away from the object, this indicates that the object is moving at a time when the user is too far away to be the one moving it, and an alert would be triggered.

In some embodiments, the processing unit 344 is adapted to alert the user or other parties when the tracking device is moving relative to the surface of the earth and the self-location reporting system 346 is not moving in the same speed and direction as the tracking device. For example, if the tracking device is affixed to an object and is moving at 5 miles per hour, and the user holding the self-location reporting system is nearby but on a bus moving 35 miles per hour, this indicates that the object is moving without the user accompanying it, and an alert would be triggered. Also for example, if the tracking device is affixed to an object and is moving at 5 miles per hour, and the user is nearby but not moving, this also indicates that the object is moving without the user accompanying it, and an alert would be triggered.

In some embodiments, the spatial tracking device 130 and receiver 342 are adapted to communicate with each other using telecommunications and networking technologies, including but not limited to cellular networks, Global Positioning System (GPS) or other global navigation satellite systems, Bluetooth, Radio Frequency Identification (RFID), femtocell, macrocell, or a combination of multiple technologies or methods. (See FIGS. 3A, 3B for representative diagrams.)

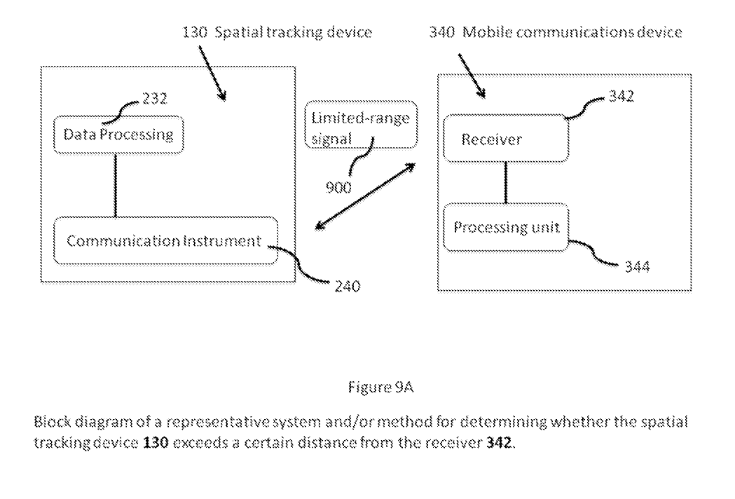

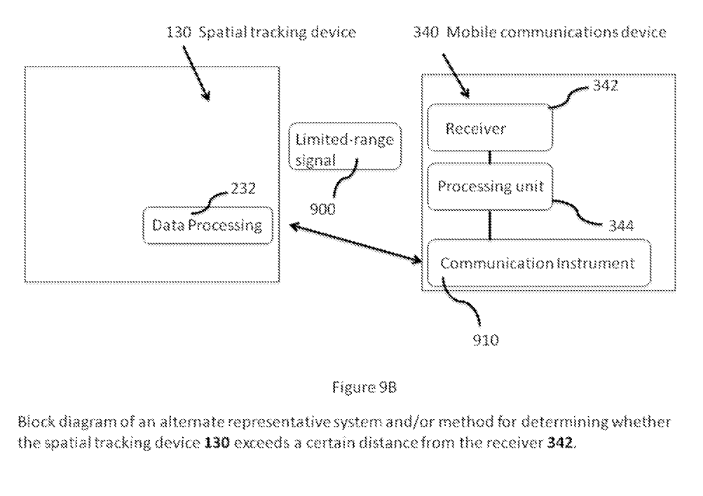

In some embodiments, the spatial tracking device 130 is adapted to use its location and/or motion detection functions only when its distance from the receiver 342 exceeds a certain range. In these embodiments, the spatial tracking device 130 would be adapted to include, or to interface with, a data processing unit 232 and would also be adapted for two-way communication between the spatial tracking device 130 and the receiver 342. (See FIGS. 9A, 9B for representative diagrams.) The technology for determining whether the said certain range has been exceeded might include, but is not limited to, a communication instrument 240 which transmits a limited-range signal from one device which will only be received by the other device if they are sufficiently close to each other. For example, the tracking device might be preprogrammed to communicate with the receiver using Bluetooth, and to interpret a lack of a Bluetooth signal from the receiver as a sign that the user is far enough away that it makes sense to alert the user with location information or to activate theft-detection components, including self-location and/or motion tracking. This can aid in finding lost or misplaced objects immediately, preventing theft from inadvertent abandonment. This can also result in longer battery life, as some of the energy-consuming features of the tracking device are not activated unless the user is far enough away to make theft a realistic possibility.

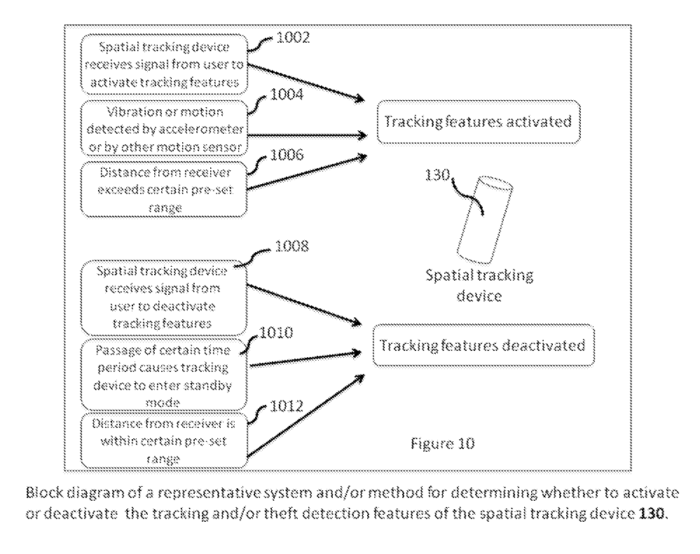

In some embodiments, the spatial tracking device 130 is adapted to use its location and/or motion detection functions only after a user directs or commands said functions to activate. (See FIG. 10 for a representative diagram.) This can allow the user to determine for him or herself whether theft is a realistic enough possibility to justify the consumption of power and/or battery life by the tracking device.

In some embodiments, the spatial tracking device 130 is adapted to use its location and/or motion detection functions only after detecting a signal from an accelerometer or other motion-activated sensor. (See FIG. 10 for a representative diagram.) This can result in certain theft-detection features remaining inactive until such things as motion or vibration (which can correspond to an object's theft) take place.

In some embodiments, the spatial tracking device 130 is adapted to temporarily deactivate its tracking and/or theft detection features if it receives a signal from the user directing it to do so. (See FIG. 10 for a representative diagram.)

In some embodiments, the spatial tracking device 130 is adapted to temporarily deactivate its tracking and/or theft detection features by entering a temporary standby mode after the passage of a certain predetermined time period. (See FIG. 10 for a representative diagram.)

Methods for using the system to connect a spatial tracking device 130 with a first receiver 342 and connect the receiver 342 with a processing unit 344 can comprise the following steps. A receiver 342 is connected or linked with a processing unit 344, either one of which is connected or linked with a self-location reporting system. A communication link is established between the receiver 342 and a spatial tracking device 130 which possesses the capability to be affixed to a physical object. The processing unit 344 uses predetermined programming to analyze data received from the receiver 342 and/or data received from the self-location reporting system. The processing unit 344 can respond to this analysis by sending predetermined information to either user-selected parties or predetermined parties. (See FIGS. 6, 7 for representative diagrams.) For example, the processing unit can determine whether the spatial tracking device exceeds a certain predetermined distance 610 from the receiver, whether the tracking device is moving, whether the tracking device is moving without the user moving in the same direction and with the same speed, and/or whether or not to classify this activity as “unauthorized movement”. The processing unit can respond by sending, to other parties or law enforcement, pre-programmed descriptive information about the object as well as the time and location that the tracking device's unauthorized movement took place, and/or the current location, speed, and direction of motion of the tracking device. The processing unit can also respond by transmitting location and/or motion information about the object to a remote computer server, web site, or other computing device from which the information can be accessed by others.

Methods for determining whether the distance of the spatial tracking device 130 exceeds a certain distance from the receiver 342 can comprise the following steps. A limited-range signal is transmitted from one device which will only be received by the other device if they are sufficiently close to each other. A data processing unit 232 included with or interfacing with the spatial tracking device 130 determines whether or not the signal is being received at a certain predetermined strength or proximity 610; if not, said data processing unit 232 directs the spatial tracking device 130 to begin self-location and/or motion tracking. (See FIGS. 9A, 9B for representative diagrams.) For example, the tracking device might be preprogrammed to transmit a Bluetooth signal to the receiver, and/or to receive a Bluetooth signal that the receiver is transmitting, and to interpret a lack of a Bluetooth signal from the receiver as a sign that the user is far enough away that it should activate theft-detection components, which might include self-location and/or motion tracking. This may result in longer battery life of the tracking device, as some of its energy-consuming features will not be activated unless the user is sufficiently far away to make theft a realistic possibility.

Methods for determining whether an object is being moved or vibrated in a way that could be unauthorized can comprise the following steps. A spatial tracking device is affixed to the object. An accelerometer or other motion-activated sensor, which interfaces with or is included with the spatial tracking device, detects whether or not motion or vibration is taking place. If so, the accelerometer or other motion-activated sensor then sends a signal which results in the activation of pre-existing theft-detection features. (See FIG. 10 for a representative diagram.) Such features might include location tracking or motion tracking of the spatial tracking device, and/or a calculation of relative motion of the spatial tracking device compared to motion and/or location of a second device designed to accompany the object's owner, in addition to automatic or manual alerts transmitted to law enforcement or other third parties.

Some methods may encompass a series of steps wherein a user can bypass certain steps and use only the steps most relevant at a given time. For example, if the tracking system happened to be deactivated, but the user discovers that his/her item is missing (i.e., lost, misplaced, or stolen), then he or she could directly execute such steps as remotely activating the tracking features of the spatial tracking device and/or sending an immediate alert to others.

1. A system for tracking, monitoring, and processing information relating to the location of a physical object, said system comprising:
a spatial tracking device, said device being capable of transmitting spatial data related to its location;
a receiver capable of being connected to said spatial tracking device through a communications link;
a processing unit capable of processing location data and other context-sensitive information; and
a self-location reporting system capable of determining and reporting its location, and being affixed to either the first receiver or the processing unit.

2. A system as in claim 1, wherein the processing unit is capable of communicating received information and processed information.

3. A system as in claim 1 or 2, wherein the processing unit is capable of determining whether the tracking device is moving relative to the surface of the earth while the first receiver is a predetermined distance away from the tracking device.

4. A system as in claim 1 or 2, wherein the processing unit is capable of determining whether the tracking device is moving relative to the surface of the earth while the first receiver is not moving in the same speed and direction as the tracking device.

5. A system as in claim 1 or 2, wherein the spatial tracking device is adapted to use its location and/or motion detection functions only when its distance from the receiver exceeds a certain range.

6. A system as in claim 1 or 2, wherein the spatial tracking device is adapted to use its location and/or motion detection functions only when a user directs or commands the location and/or motion detection functions to activate.

7. A system as in claim 1 or 2, wherein the spatial tracking device is adapted to use its location and/or motion detection functions only when an accelerometer or other motion-activated sensor, included with or interfacing with said spatial tracking device, detects vibration or motion.

8. A system as in claim 1 or 2, wherein the processing unit is adapted to include or interface with an application which allows the user to set preferences, said preferences governing the ways in which information is stored, communicated to other parties, and received from other parties.

9. A method for tracking, monitoring, and processing information relating to the location of a physical object, comprising the steps of:
linking a first receiver with a processing unit;
linking either the first receiver or the processing unit with a self-location reporting system;
linking the first receiver to a spatial tracking device which possesses the capability to be affixed to a physical object; and
using predetermined programming to analyze data received from the first receiver and/or data received from the self-location reporting system.

10. A method as in claim 9, comprising the additional step of sending predetermined information to either user-selected parties or predetermined parties.

11. A method as in claim 9 or 10, comprising the additional step of using predetermined programming to determine whether the tracking device is moving relative to the surface of the earth while the first receiver is a predetermined distance away from the tracking device.

12. A method as in claim 9 or 10, comprising the additional step of using predetermined programming to determine whether the tracking device is moving relative to the surface of the earth while the first receiver is not moving in the same speed and direction as the tracking device.

13. A method for determining whether the distance of a spatial tracking device exceeds a certain distance from a receiver comprising the steps of:
transmitting a limited-range signal from one device which will only be received at a certain strength or proximity by the other device if they are sufficiently close to each other;
determining whether the signal is being received by the other device at a certain strength or proximity or not, and if not, directing the spatial tracking device to begin self-location and/or motion tracking.

14. A method as in claim 13, comprising the additional steps of:
transmitting a limited-range signal from one device which will only be received at a certain strength or proximity by the other device if they are sufficiently close to each other;
determining whether the signal is being received by the other device at a certain strength or proximity or not, and if not, directing the spatial tracking device to begin self-location and/or motion tracking.

15. A method as in claim 13, comprising the additional steps of:
using an accelerometer or other motion-activated sensor to detect vibration or motion;
signaling the spatial tracking device, through use of said accelerometer or other motion-activated sensor, to activate theft-detection features.
